(19) United States
(12) Patent Application Publication
(10) Pub. No.: US 2006/0150342 A1
(43) Pub. Date: Jul. 13, 2006

(54) Stuffing agent for leather based on mixtures of modified, native oils with alcoxylated alkanols, use thereof and method for treating leather

(75) Inventors: Ralph Lunkwitz, Neustadt (DE); Andreas Seitz, Birkenheide (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/526,895

(22) PCT Filed: Sep. 11, 2003
(86) PCT No.: PCT/EP03/10113

§ 371 Date: Sep. 27, 2005

(30) Foreign Application Priority Data
Sep. 12, 2002 (DE) 102 42 401.2

(51) Int. Cl. C14C 1/06

(52) U.S. Cl. 8/94.16

(57) ABSTRACT

A fatliquoring agent comprises A) a mixture of modified natural oils containing a1) at least one oxidized sulfited natural oil and a2) at least one oxidized sulfated natural oil, B) an emulsifier mixture containing
b1) at least one C₆- to C₁₄-alkanol alkoxylated with from 4 to 12 alkylene oxide units,
b2) at least one C₁₂- to C₂₄-alkanol alkoxylated with from 15 to 40 alkylene oxide units and
b3) at least one C₁₂- to C₂₄-alkanol alkoxylated with from 50 to 100 alkylene oxide units, and
C) if required, a linear, cyclic or branched polymer of a dialkylsilanediol, SiR₂(OH)₂, where R is methyl, ethyl, n-propyl or phenyl, and/or
   D) if required, a compound of the formula (II) 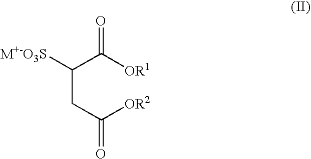
   where R¹ and R² are identical or different and, independently of one another, are selected from the group consisting of H, M, saturated linear aliphatic C₁- to C₁₈-alkyl and saturated branched aliphatic C₃- to C₁₈-alkyl,
   where at least one of the two radicals R¹ and R²≠H, M with M=alkali metal or 0.5 alkaline earth metal, and M⁺ is selected from the group consisting of H⁺, NH₄⁺, alkali metal⁺ and 0.5 alkaline earth metal⁺. The use of the novel fatliquoring agents in leather production and/or leather treatment and processes for the production and/or treatment of leather with aqueous dispersions of these fatliquoring agents are also described.

The present invention relates to fatliquoring agents based on modified, natural oils of alkoxylated alkanols, their use in the production and/or treatment of leather and hides, and processes for the production and/or treatment of leather and hides using these fatliquoring agents.

Fatliquoring agents are used in leather production for softening the leather, for increasing its body and strength and for protection from moisture, dirt and external chemical influences (cf. H. Herfeld, “Bibliothek des Leders” 1985, Volume 4, page 13 et seq.). Commercial fatliquoring agents consist, as a rule, of fat-imparting substances, such as natural fats, natural oils, waxes, resins and derivatives thereof and/or mineral oil fractions and secondary products thereof, and wax-like products, such as “wool fat”, in crude, purified and/or prepared (lanolin) form (cf. H. Herfeld, “Bibliothek des Leders” 1985, Volume 4, page 59 et seq.). The fat-imparting substances can—if desired—be chemically modified, i.e. can be present in a modified chemical structure.

The chemical modification of the fat-imparting substances consists, as a rule, in subjecting at least some of the double bonds contained in these substances to addition reactions or oxidation reactions. Frequently performed modifications consist, for example, of an addition reaction with sulfites, with the result that sulfo groups are introduced into the fat-imparting substances, or in atmospheric oxidation, with the result that oxygen functions are introduced and in some cases oligomerizations also occur. However, (partial) hydrolysis of the fats, transesterifications and similar modification reactions are also possible.

These chemical modifications make it possible optimally to adapt the application-relevant properties of the fat-imparting substances, such as hydrophilic character, hydrophobic character, solubility, dispersing power, penetration and anchoring properties, to specific intended uses or to the users' requirements. In particular, high-quality automotive upholstery leathers have to fulfill certain criteria. On the one hand, the softness of the leather and, on the other hand, the fastness to light and heat and finally the fogging behavior are important.

DIN 75201 defines “fogging” as condensation of vaporized components from the vehicle interior trim, such as the automotive upholstery leathers, on the glass panes, in particular on the windscreen. This can lead to poorer vision through the windscreen, in particular when driving at night, and hence to a safety risk. According to DIN 75201, the fogging behavior of leather is characterized by a gravimetric and a reflectometric method.

In order to prevent undesired fogging, it is therefore an object to reduce the proportion of organic compounds which can emerge again from the treated leather after processing (“volatile organic compounds”). However, the use of organic compounds, such as solvents, is sometimes difficult to avoid. This is because the fatliquoring agent is often diluted with solvent for application, in order to ensure a good distribution of the fatliquoring agent on the leather. The prior art discloses some possibilities for avoiding this problem.

Thus, EP-A 0 498 634 recommends special polymers for the production of leathers having low fogging properties. Here, the aqueous dispersions used in the leather treatment are substantially free of organic solvents and contain an amphiphilic copolymer. This copolymer consists of a predominant proportion of at least one hydrophobic monomer and a small proportion of at least one hydrophilic monomer. The leather treatment with these dispersions leads to good results in a gravimetric test according to DIN 75201. Reflectometric investigations were not described.

These amphiphilic copolymers are preferably prepared by emulsion polymerization in aqueous solution. Owing to the different hydrophilic characters of the monomers used, however, problems with the copolymerization behavior do of course arise. In the extreme case, this can lead to the monomers each undesirably forming homopolymers. A further consequence of the essentially unfavorable solution ratio is a complicated working-up for destroying unconverted monomers. In order to achieve good emulsion stability, it is moreover necessary to add a sufficient amount of an emulsifier (lauryl sulfate was used in the examples mentioned), which can lead to wastewater problems in the leather processing.

EP-B 0 466 392 describes a process for the preparation of polymers which contain both hydrophobic side groups and hydrophilic alkoxylated side groups. Such polymers are obtained by carrying out derivatization reactions—known to a person skilled in the art—after the actual polymerization process. Thus, polymers of simple monomers, such as acrylamide and/or acrylic acid, are preferably prepared by conventional polymerization and then derivatized with a mixture of primary or hydrophobic amines or primary or secondary alkoxylated amines. The polymers described are used as thickeners and dirt removers. Their use in leather treatment is not described.

In the process according to WO 98/10103, polymeric fatliquoring agents are prepared by polymerization of acrylic acid and/or methacrylic acid and/or the acid chlorides thereof and/or the anhydrides thereof with further copolymerizable water-soluble monomers and with copolymerizable water-insoluble monomers and subsequent reaction of the polymers thus obtained with amines. According to DIN 75201 B (gravimetric test), fogging values of 1.2 mg or 1.5 mg are obtained for leathers which have been treated with these polymeric fatliquoring agents. The leathers treated with the comparative products Magnopal® SOF (low-fogging polymer fatliquoring agent from Stockhausen GmbH & Co. KG) and Chromopol® LFC (low-fogging fatliquoring agent based on fish oils from Stockhausen GmbH & Co. KG) achieve fogging values of 3.9 mg and 3.5 mg, respectively. The reflectometric values according to DIN 75201 A of the polymeric fatliquoring agents are 51% and 55%, respectively, and those of the comparative products 34% and 40%, respectively.

U.S. Pat. No. 5,348,807, too, describes a process in which selected amphiphilic copolymers, consisting of a predominant proportion of hydrophobic and a smaller proportion of hydrophilic structural groups, are used as solvent-free low-fogging fatliquoring agents. For the preparation of these polymers, acidically or basically substituted esters of unsaturated carboxylic acids, e.g. sulfatoethyl (meth)acrylate or dimethylaminoethyl (meth)acrylate, are used as hydrophilic monomers. For example, longer-chain alkenes or (meth)acrylic esters of C₄- to C₁₂-alkanols or vinyl esters of C₄- to C₁₂-carboxylic acids serve as hydrophobic monomers. The substances give good fogging values; however, data on the bath exhaustion are lacking.

In this process, too, the preparation of the amphiphilic copolymer is preferably effected by aqueous emulsion polymerization. However, owing to the different hydrophilic characters of the monomers to be used, this once again leads to the problems already mentioned in the discussion of EP-A 0 498 634.

EP-B 0 753 585 describes a low-fogging surface treatment for furniture leather, in which the specially treated natural oils, which contain less than 3% of fatty acid components of less than 16 carbon atoms, act as a basis for fatliquoring agents. Natural oils used are soybean, lard, safflower and sunflower oil. Said natural oils are first distilled in order to remove the undesired low molecular weight components and then reacted with bisulfite or bisulfate in order to improve emulsifiability. The (partly) functionalized oils are then emulsified and used.

According to the non-prior-published DE-A 101 43 949.0 of the Applicant, a special emulsifier composition which comprises three components A, B and C is used in order to avoid the use of organic solvents for distributing the fatliquoring agents. Here, the component A is a C₆- to C₁₄-alkanol alkoxylated with from 4 to 12 alkylene oxide units, or a mixture of a plurality of such alkanols, the component B is a C₁₂-C₂₄ fatty alcohol mixture alkoxylated with from 15 to 40 alkylene oxide units and the component C is a C₁₂ to C₂₄ fatty alcohol mixture alkoxylated with from 50 to 100 alkylene oxide units. The alkylene oxide units are expediently alkylene oxide building blocks of 2 to 4, preferably 2 or 3, carbon atoms. The building blocks of the polyether chains may all be identical or different and—if they are different—may be arranged randomly or blockwise. The amounts by weight of the components in the emulsifier composition are from 20 to 60, preferably from 25 to 50, in particular from 28 to 40, % by weight for component A, from 20 to 70, preferably from 25 to 60, in particular from 30 to 45, % by weight for component B and from 10 to 50, preferably from 15 to 40, in particular from 22 to 32, % by weight for component C, based on the total weight of the composition.

According to the non-prior-published DE 102 07 277.9 of the Applicant, fatliquoring agents which contain at least one modified natural oil and at least one stabilizer LₙR are used in particular for fatliquoring of leathers and hides tanned without chromium. Here, R is an n-valent saturated or unsaturated, linear aliphatic C₃- to C₃₀- or branched aliphatic C₄- to C₃₀- or (hetero)cycloaliphatic C₄- to C₃₀- or (hetero)aromatic C₄- to C₃₀-hydrocarbon radical, unsubstituted or substituted by carbonyl, alkylcarbonyloxy, alkylcarbamoyl and/or alkoxycarbonyl groups and/or containing O, N(H) and/or S units, n is an integer from 1 to 10 and L is a hydroxyphenyl radical which is substituted by R^{a}, R^{b} and R^{c}. R^{a} is H or methyl, R^{b} is methyl, ethyl or tert-butyl and R^{c} is methyl, tert-butyl, cyclohexyl or methylcyclohexyl. Moreover, the stabilizer LₙR has a total of at least 20 carbon atoms, in particular a total of at least 28 carbon atoms, and, where n is 2, —R— is also —S—, —O—, —N(H)—, —CH₂—, —(CH₂)₂—, —CH(CH₃)—, —(CH₂)₃—, —CH(C₂H₅)— or —C(CH₃)₂—.

Common to all prior art processes described above is that they employ either polymers or fatliquoring agents based on chemically modified natural oils and that these products are special, relatively narrowly limited classes of substances. Good liquor exhaustion and accordingly a high-exhaustion fatliquoring agent are present when the fatliquoring agent is absorbed as completely as possible by the collagen of the leathers and/or hides. This is desirable from points of view of environmental protection, because the wastewater is thus less polluted, and with regard to economic aspects, because the wastewater treatment is then less expensive.

In the case of wet blue semifinished products, i.e. chrome-tanned semifinished products, the generally anionic fatliquoring agent is fixed by the chromium(III) cations. Wet white semifinished products, i.e. semifinished products tanned without chromium, are produced without cationic metal salts, and these binding sites are therefore absent. With the use of commercial fatliquoring agents which are prepared according to the prior art, the bath exhaustion is often insufficient, i.e. the residual liquor has a high COD. According to the prior art, the bath exhaustion is improved by chemical modification of the fatliquoring agent which as a rule is effected by deposition of the fatliquoring components on the leather surface. As a result of this, the compounds are poorly fixed in the leather and hence leather having high fogging values according to DIN 75201 are obtained.

It is an object of the present invention to provide a fatliquoring agent which substantially avoids the disadvantages of the prior art. The leathers treated with these fatliquoring agents should be sufficiently exhausting and, if required, should have sufficient fastness to light and heat and should have a low VOC content. The novel fatliquoring agents should also permit good coloring and embossing of the leather.

The object is achieved, according to the invention, by a fatliquoring agent comprising
A) a mixture of modified natural oils containing
   a1) at least one oxidized sulfited natural oil and
   a2) at least one oxidized sulfated natural oil,
B) an emulsifier mixture containing
   b1) at least one C₆- to C₁₄-alkanol alkoxylated with from 4 to 12 alkylene oxide units,
   b2) at least one C₁₂- to C₂₄-alkanol alkoxylated with from 15 to 40 alkylene oxide units and
   b3) at least one C₁₂- to C₂₄-alkanol alkoxylated with from 50 to 100 alkylene oxide units, and
C) if required, a linear, cyclic or branched polymer of a dialkylsilanediol, SiR₂(OH)₂, where R is methyl, ethyl, n-propyl or phenyl, and/or
D) if required, a compound of the formula (II) 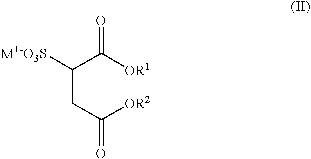
   where R¹ and R² are identical or different and, independently of one another, are selected from the group consisting of H, M, saturated linear aliphatic C₁- to C₁₈-alkyl and saturated branched aliphatic C₃- to C₁₈-alkyl,
   where at least one of the two radicals R¹ and R²≠H, M with M=alkali metal or 0.5 alkaline earth metal, and
   M⁺ is selected from the group consisting of H⁺, NH₄⁺, alkali metal⁺ and 0.5 alkaline earth metal⁺.

The novel fatliquoring agents are particularly suitable for fatliquoring leathers and hides since the leathers and hides treated in this manner exhibit little fogging and have low VOC values. In particular, the leathers and hides treated in this manner can be readily colored and embossed and have a pleasant handle. The presence of the novel fatliquoring agents in the leather treatment liquors (undiluted or in the form of aqueous dispersions, see below) does in fact lead to good bath exhaustion and hence to low CODs in combination with good anchoring of the fatliquoring agents in the interior of the leathers.

Components A to D are now explained in more detail below.

Component A

The natural oils used are expediently fats of vegetable or animal origin, in particular glycerides of natural fatty acids, with a sufficient proportion of unsaturated acids. Suitable natural oils are those having an iodine number from about 10 to about 200. The lower section of this range includes, for example, oleic acid and tung oil, while the upper section includes in particular the fish oils and chaulmoogra oil.

Natural oils having iodine numbers of from about 30 to about 120, in particular from 40 to 85, are preferred.

Examples of particularly preferred modified natural oils are modified fish oil, neatsfoot oil, lard oil, soybean oil, rapeseed oil, walnut oil, olive oil and castor oil.

Modified natural oils which have a relatively high degree of oxidation and a relatively low degree of sulfitation or sulfation are particularly advantageous.

The oxidation products, sulfitation products or sulfation products of the mono- or polyunsaturated fats form by the reaction of olefinic double bonds present in the fats with the oxidation, sulfitation or sulfation reagents. All double bonds present in the fats or only a part thereof may participate in the reaction.

For example, air at from 60 to 80° C. is used as the oxidizing reagent. However, the oxidation can also be carried out by other methods known to a person skilled in the art. A relatively high degree of oxidation is present in the context of this invention if Δd, the difference between the specific gravities of the oil or fat before and after the oxidation, is from 0.01 to 0.1, preferably from 0.03 to 0.05, g/ml.

The sulfitation is generally effected by reaction in aqueous Na₂S₂O₅ solution. However, it can also be effected by other methods known to a person skilled in the art. A relatively low degree of sulfitation in the context of this invention is present when the natural oil has been reacted with from 2 to 8, preferably from 3 to 5, % by weight, based on its weight, of a sulfite, calculated as sodium bisulfite (Na₂S₂O₅).

The oxidized, sulfited natural oil is obtained by oxidizing natural oil in such a way that the difference Δd between the specific gravities of the unoxidized and oxidized natural oil is from 0.01 to 0.1, preferably from 0.03 to 0.05, g/ml, and then reacting the natural oil thus oxidized with from 2 to 8, preferably from 3 to 5, % by weight, based on its weight, of sulfite—calculated as sodium bisulfite (Na₂S₂O₅).

The sulfation is effected in general by reaction in ≧60, preferably ≧98, % strength by weight aqueous H₂SO₄ solution. The purity of the solution need not meet any particular requirements, so that even technical-grade H₂SO₄ solution may be used. The sulfation is therefore particularly preferably effected in concentrated technical-grade H₂SO₄ solution. The use of oleum is also possible. However, the reaction can also be effected by other methods known to a person skilled in the art, for example by reaction with SO₃ or ClSO₃H. A relatively low degree of sulfation in the context of this invention is present when the natural oil has been reacted with from 3 to 9, preferably from 4 to 8, % by weight, based on its weight, of H₂SO₄—calculated as 98% strength by weight aqueous H₂SO₄ solution.

The oxidized, sulfated natural oil is obtained by oxidizing natural oil so that the difference Δd between the specific gravities of the unoxidized and oxidized natural oil is from 0.01 to 0.1, preferably from 0.03 to 0.05, g/ml, and then reacting the natural oil oxidized in this manner with from 3 to 9, preferably from 4 to 8, % by weight, based on its weight, of H₂SO₄—calculated as 98% strength by weight aqueous H₂SO₄ solution.

Component B

Component B is an emulsifier mixture comprising the individual components b1, b2 and b3. The alkylene oxide units of the alkanols alkoxylated therewith are expediently those of 2 to 4, preferably 2 or 3, carbon atoms, i.e. the alkoxylated relatively long-chain and long-chain alkanols which are known from the prior art are obtained by reacting the corresponding alkanols or alkanol mixtures, as present in fatty alcohols, with the desired molar amounts of the alkylene oxides, such as ethylene oxide, propylene oxide or butylene oxide. Depending on the manner in which the alkylene oxides are to be metered into the batches, the units of the polyether chains obtained therefrom may be all identical or different and—if they are different—may be arranged randomly or blockwise. The reaction can be catalyzed by small amounts of water and/or alkali.

The emulsifier mixture contains in particular from 20 to 60, preferably from 25 to 50, particularly preferably from 28 to 40, % by weight of a component b1 or of a mixture of the components b1, from 20 to 70, preferably from 25 to 60, particularly preferably from 30 to 45, % by weight of a component b2 or of a mixture of the components b2 and from 10 to 50, preferably from 15 to 40, particularly preferably from 22 to 32, % by weight of a component b3 or of a mixture of the components b3—based in each case on the total weight of the emulsifier mixture.

Component b1 is preferably at least one C₈- to C₁₂-alkanol alkoxylated with from 4 to 12 alkylene oxide units, particularly preferably at least one C₁₀-alkanol alkoxylated with from 4 to 12 alkylene oxide units. Component b2 is preferably at least one C₁₄- to C₂₀-alkanol alkoxylated with from 15 to 40 alkylene oxide units, particularly preferably a C₁₆- to C₁₈-alkanol alkoxylated with from 15 to 40 alkylene oxide units. Component b3 is preferably at least one C₁₄- to C₂₀-alkanol alkoxylated with from 50 to 100 alkylene oxide units, particularly preferably a C₁₆- to C₁₈-alkanol alkoxylated with from 50 to 100 alkylene oxide units.

Moreover, component b1 is preferably alkoxylated with from 5 to 10 alkylene oxide units and/or component b2 with from 20 to 30 alkylene oxide units and/or component b3 with from 50 to 100 alkylene oxide units. Particularly preferably, component b1 is alkoxylated with from 5 to 10 alkylene oxide units and component b2 with from 20 to 30 alkylene oxide units and component b3 with from 50 to 100 alkylene oxide units.

Component C

Component C is the reaction product which is obtained by polymerization of a dialkylsilanediol SiR₂(OH)₂, where R is methyl, ethyl, n-propyl or phenyl. The polymer thus obtained may be linear, cyclic or branched. It preferably has a viscosity of from 30 to 1 000, particularly preferably from 80 to 500, mPa·s—measured in the pure substance at 20° C. Component C can be either a homopolymer or a copolymer. The novel fatliquoring agent may contain either no components C or one or more components C. The novel fatliquoring agent preferably contains at least one component C.

The polymers of the formula (I) and their preparation are known to a person skilled in the art and are described, for example, in EP-A 0 213 480, in Jürgen Falbe, Manfred Regitz, Römpp Chemie Lexikon 1992, 9th edition, Georg Thieme Verlag Stuttgart—New York, Volume 5, page 4167 et seq., in particular under “Silicone” and “Siloxane”, and in Ullmanns Enzyklopadie der technischen Chemie 1982, 4th edition, Verlag Chemie Weinheim, Volume 21, pages 511-543, in particular under “Silicon-Öle”. The silicone oils described in EP-A 0 213 480 are hereby incorporated by reference.

Component D

The compound of the formula II 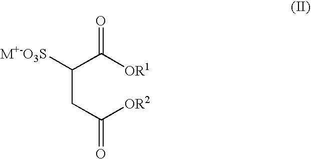
where R¹ and R² are identical or different and, independently of one another, are selected from the group consisting of H, M, saturated linear aliphatic C₁- to C₁₈-alkyl and saturated branched aliphatic C₃- to C₁₈-alkyl,
where at least one of the two radicals R¹ and R²≠H, M with M=alkali metal or 0.5 alkaline earth metal, and
M⁺ is selected from the group consisting of H⁺, NH₄+, alkali metal⁺ and 0.5 alkaline earth metal⁺, is a sulfited succinic mono- or diester. The diesters may be either mixed esters or diesters of the same alcohol. They are preferably diesters of the same alcohol.

The novel fatliquoring agent may contain either no compounds of the formula II or one or more of the compounds of the formula (II). Preferably, the novel fatliquoring agent contains at least one compound of the formula (II).

R¹ and R², independently of one another, are preferably from the group consisting of methyl, ethyl, propyl, isopropyl, n-butyl, sec-butyl, tert-butyl, n-pentyl, isopentyl, n-hexyl, 2-ethylhexyl, n-octyl, n-dodecyl, n-tridecyl, n-tetradecyl and nhexadecyl and/or M⁺ is H⁺ or Na⁺.

The compound of the formula (II) can be prepared by a process comprising the following steps:
i) reaction of at least one substance selected from the group consisting of maleic anhydride, maleic acid and fumaric acid with at least one saturated aliphatic C₁- to C₁₈-alkanol in a molar ratio of (0.1 to 1): (2 to 5) to give a compound of the formula (IIIa) or (IIIb) 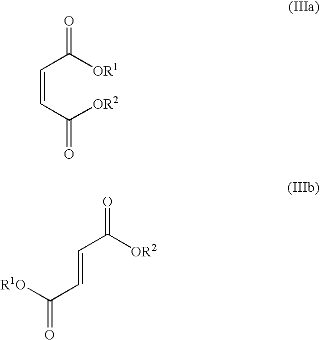
   where R¹ and R² are identical or different and, independently of one another, are selected from the group consisting of H, saturated linear aliphatic C₁- to C₁₈-alkyl and saturated branched aliphatic C₃- to C₁₈-alkyl, where at least one of the two radicals R¹ and R²≠H, and
ii) reaction with the compounds of the formula (IIIa) or (IIIb) which are obtained by step i) with a derivative of sulfurous acid, in particular with Na₂S₂O₅, to obtain a compound of the formula (II) where M⁺ is Na⁺.

Maleic anhydride is preferably used in step i). Preferably used alkanols are methanol, ethanol, propanol, isopropanol, 1-butanol, 2-methylpropanol, tert-butanol, 1-pentanol, 3-methylbutanol, 2,2-dimethylpropanol, 1-hexanol, 2-ethylhexanol, 1-octanol, 1-dodecanol, 1-tridecanol, 1-tetradecanol and 1-hexadecanol.

During the process, the pressure is in particular from 1 bar (=atmospheric pressure) to 5 bar. The process is preferably carried out at from 80 to 100° C., the upper limit for the reaction temperature being predetermined by the boiling point of the alcohol used. Further details of the method for carrying out the process and of the preparation of the other compounds of the formula (II) are known to a person skilled in the art.

The novel fatliquoring agent can be used in the production and/or treatment of leather and hides. The present invention therefore also relates to the use of the described novel fatliquoring agents in leather production. They are used for softening the leather, for increasing its body and strength and for protecting it from moisture, dirt and external chemical influences.

The novel fatliquoring agent can be provided in undiluted form or, depending on the users' requirements, in the form of aqueous dispersions (aqueous compositions), expediently having solids contents of from 40 to 80, preferably from 50 to 80, particularly preferably from 60 to 75, % by weight. The present invention therefore also relates to a process for the fatliquoring of leathers and hides by treatment with the abovementioned aqueous compositions.

The preferred, particularly preferred and very particularly preferred compositions of the novel fatliquoring agents are shown in table 1 below. The stated weights are based in each case on the total weight of the fatliquoring agent. Further suitable additives known to a person skilled in the art may also be present.

TABLE 1
Composition of the novel fatliquoring agent

| One or | | | |
|---|---|---|---|
| more of | | | Very particularly |
| the com- | Preferred | Particularly prefer- | preferred |
| ponents | composition | red composition | composition |
| A | 45 to 98% by wt. | 70 to 96% by wt. | 78 to 95% by wt. |
| B | 2 to 15% by wt. | 3 to 10% by wt. | 3 to 8% by wt. |
| C | 0 to 20% by wt. | 0.5 to 10% by wt. | 1 to 7% by wt. |
| D | 0 to 20% by wt. | 0.5 to 10% by wt. | 1 to 7% by wt. |

The components of the preferred novel fatliquoring agent, i.e. the novel modified natural oils (component A) and the novel emulsifier mixture (component B), and, if required, the polymer of the formula I (component C) and the compound of the formula (II) (component C), can be added to the fatliquoring liquors together, i.e. in form of a composition, or separately in any desired order—with stirring and, if required, gentle heating.

The examples which follow illustrate the invention.

### EXAMPLES

The composition of the novel fatliquoring agents FM1 to FM4 used is shown in table 2. The amount of the individual components is stated in % by weight, based on the total fatliquoring agent.

Component a1 is a 93% strength by weight aqueous solution of oxidized sulfited rapeseed oil, the rapeseed oil having been oxidized in air to Δd=0.01 to 0.1 g/ml and then having been reacted with 4% by weight of Na₂S₂O₅—based on the weight of the rapeseed oil. Component a2 is a 96% strength by weight aqueous solution of oxidized sulfated rapeseed oil, the rapeseed oil having been oxidized in air to Δd=0.01 to 0.1 g/ml and then having been reacted with 6% by weight of 98% strength by weight aqueous H₂SO₄—based on the weight of the rapeseed oil.

The nonionic surfactant Lutensol® AT 25 from BASF AG in Ludwigshafen is a C₁₆- to C₁₈-fatty alcohol mixture which was ethoxylated with 25 mol of ethylene oxide. The nonionic surfactant Siligen® from BASF AG in Ludwigshafen is a mixture of linear C₁₆- to C₁₈-fatty alcohols which was ethoxylated with 18 mol of ethylene oxide. The nonionic surfactant Lutensol® ON 70 from BASF AG in Ludwigshafen is a linear C₁₀-fatty alcohol which was ethoxylated with 7 mol of ethylene oxide.

The dialkyl sulfosuccinate Empimin® AMI from BASF AG in Ludwigshafen is the reaction product of maleic anhydride with 2-ethylhexanol in a molar ratio of 1:2, the product subsequently being subjected to sulfite addition of the double bond of the maleic (di)ester thus obtained. The Silikonol® AK 350 from Wacker Chemie in Burghausen is a polydimethylsiloxane having a viscosity of 350 mPa·s—measured at 20° C. Densodrin® BA from BASF AG in Ludwigshafen is a 25% strength by weight aqueous solution of the copolymer which was obtained by polymerization of a mixture of α-olefins of 20 to 24 carbon atoms with maleic anhydride in a molar ratio of 1:1 and subsequent neutralization with aqueous NaOH solution and has a number average molar mass Mₙ of 10 000 g/mol.

TABLE 2
Composition of the fatliquoring agents FM1 to FM4

| Component | FM 1 | FM 2 | FM 3 | FM 4 |
|---|---|---|---|---|
| a1 [% by weight] | 61.3 | 50.3 | 40.3 | 58.3 |
| a2 [% by weight] | 26.5 | 35.8 | 45.8 | 26.5 |
| Lutensol ® AT 25 | 2.0 | 2.0 | 2.0 | 2.0 |
| [% by weight] | | | | |
| Siligen ® WL [% by weight] | 1.4 | 1.4 | 1.4 | 1.4 |
| Lutensol ® ON 70 [% by weight] | 1.8 | 1.8 | 1.8 | 1.8 |
| Silikonöl AK 350 [% by weight] | 2.0 | — | — | 5.0 |
| Empimin ® AMI [% by weight] | 5.0 | — | — | 5.0 |
| Densodrin ® BA [% by weight] | — | 8.7 | 8.7 | — |

### Example 1

Treatment of Chrome-Tanned Leather with Novel Fatliquoring Agents FM1 to FM4

100 parts by weight of chrome cattle leather having a shaved thickness of 1.0 mm are agitated in 200 parts by weight of water at 35° C. for 10 minutes in a drum. Thereafter, the liquor is discharged and the chrome cattle leather washed in this manner is agitated in a solution of 2.5 parts by weight of sodium formate in 150 parts by weight of water at 35° C. for 30 minutes. Thereafter, 0.8 part by weight of sodium bicarbonate dissolved in 12 parts by weight of water are added, resulting in a pH-value of 6.5. Agitation of the leather is continued in this liquor at 30° C. for 60 minutes. Then 2 parts by weight of fatliquoring agent FM1, diluted with water in a ratio of 1:3, are added and agitation is continued at 60° C. for another 60 minutes. The liquor is then discharged.

For retanning the leather is agitated at 35° C. for 60 minutes in a mixture of 100 parts by weight of water of 35° C., 5 parts by weight of a vegetable tanning agent (tara) and 5 parts by weight of commercial liquid sulfone tanning agent, which was diluted with water of 35° C. in a ration of 1:3. Then the leather is colored in the same liquor at 35° C. for 60 minutes, using 2.5 parts by weight of a commercial anionic leather dye.

Then 100 parts by weight of water of 60° C. are added to the liquor and after 5 minutes 10 parts by weight of fatliquoring agent FM1, diluted with water of 60° C. in a ration of 1:5, are added to the leather. The liquor then has a pH value of 6.9.

Without further heat supply the liquor is then adjusted to a pH of 3.6 by slow addition of 15 parts by weight of 8.5% strength by weight aqueous formic acid in the course of 30 minutes. Agitation of the leather is then continued for another 30 minutes period.

The liquor is discharged, and the leather is washed for 10 minutes with 200 parts by weight of water at 35° C. and is further processed in a generally customary manner.

The example was repeated analogously with the use of the fatliquoring agents FM2 to FM4.

Leather having a good tight-grained character in combination with good body and medium softness is obtained. The leather surface has a pleasant handle.

### Example 2

Treatment of Leather Tanned without Chromium with Novel Fatliquoring Agents FM1 to FM4

100 parts by weight of wet white cattle leather having a shaved thickness of 1.0 mm are agitated in 300 parts by weight of water at 35° C. for 10 minutes. Thereafter, the liquor is discharged and the cattle leather washed in this manner is agitated in a solution of 2.0 parts by weight of sodium formate in 200 parts by weight of water at 35° C. for 20 minutes. Thereafter, 0.3 part by weight of sodium bicarbonate dissolved in 4.5 parts by weight of water are added, resulting in a pH-value of 4.8. Agitation of the leather is continued in this liquor at 30° C. for 60 minutes. Then 2 parts by weight of fatliquoring agent FM1, diluted with water in a ratio of 1:3, are added and agitation is continued at 60° C. for another 60 minutes. The liquor is then discharged.

For retanning the leather is agitated at 35° C. for 120 minutes in a mixture of 100 parts by weight of water of 35° C., 6 parts by weight of a vegetable tanning agent (tara) and 20 parts by weight of commercial liquid sulfone tanning agent, which was diluted with water of 35° C. in a ration of 1:3. Then the leather is colored in the same liquor at 35° C. for 60 minutes, using 2.0 parts by weight of a commercial anionic leather dye.

Then 100 parts by weight of water of 60° C. are added to the liquor and after 5 minutes 10 parts by weight of fatliquoring agent FM1, diluted with water of 60° C. in a ration of 1:5, are added to the leather. The liquor then has a pH value of 5.0.

Without further heat supply the liquor is then adjusted to a pH of 3.5 by slow addition of 15 parts by weight of 8.5% strength by weight aqueous formic acid in the course of 30 minutes. Agitation of the leather is then continued for another 30 minutes period.

The liquor is discharged, and the leather is washed for 10 minutes with 200 parts by weight of water at 35° C. and is further processed in a generally customary manner.

The example was repeated analogously with the use of the fatliquoring agents FM2 to FM4.

Leather having a good tight-grained character in combination with good body and medium softness is obtained. The leather surface has a pleasant handle.

1-10. (canceled)

11. A fatliquoring agent for the production and/or treatment of leather and hides, comprising
A) a mixture of modified natural oils containing
a1) at least one oxidized sulfited natural oil and
a2) at least one oxidized sulfated natural oil,
B) an emulsifier mixture containing
b1) at least one C₆- to C₁₄-alkanol alkoxylated with from 4 to 12 alkylene oxide units,
b2) at least one C₁₂- to C₂₄-alkanol alkoxylated with from 15 to 40 alkylene oxide units and
b3) at least one C₁₂- to C₂₄-alkanol alkoxylated with from 50 to 100 alkylene oxide units, and
C) optionally a linear, cyclic or branched polymer of a dialkylsilanediol SiR₂(OH)₂, where R is methyl, ethyl, n-propyl or phenyl, and/or D) optionally a compound of the formula (II) 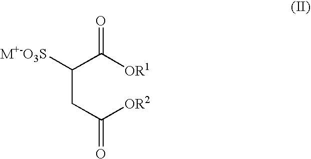
wherein R¹ and R² are identical or different and, independently of one another, are selected from the group consisting of H, M, saturated linear aliphatic C₁- to C₁₈-alkyl and saturated branched aliphatic C₃- to C₁₈-alkyl, wherein at least one of the two radicals R¹ and R²≠H, M with M=alkali metal or 0.5 alkaline earth metal, and
M⁺ is selected from the group consisting of H⁺, NH₄⁺, alkali metal⁺ and 0.5 alkaline earth metal⁺.

12. The fatliquoring agent as claimed in claim 11, wherein the oxidized sulfited natural oil is obtained by oxidizing natural oil so that the difference Δd between the specific gravities of the unoxidized and oxidized natural oil is from 0.01 to 0.1 g/ml and then reacting the natural oil oxidized in this manner with from 2 to 8% by weight, based on its weight, of a sulfite—calculated as sodium bisulfite (Na₂S₂O₅), and
wherein the oxidized, sulfated natural oil is obtained by oxidizing natural oil so that the difference Δd between the specific gravities of the unoxidized and oxidized natural oil is from 0.01 to 0.1 g/ml and then reacting the natural oil oxidized in this manner with from 3 to 9% by weight, based on its weight, of H₂SO₄—calculated as 98% strength by weight aqueous H₂SO₄ solution.

13. The fatliquoring agent as claimed in claim 11, wherein the emulsifier mixture B comprises from 20 to 60% by weight of component b 1 or of a mixture of the components b1, from 20 to 70% by weight of a component b2 or of a mixture of the components b2 and from 10 to 50% by weight of a component b3 or of a mixture of the components b3—based in each case on the total weight of the emulsifier mixture.

14. The fatliquoring agent as claimed in claim 11, wherein component b1 is at least one C₈- to C₁₂-alkanol alkoxylated with from 4 to 12 alkylene oxide units and/or component b2 is at least one C₁₄- to C₂₀-alkanol alkoxylated with from 15 to 40 alkylene oxide units and/or component b3 is at least one C₁₄- to C₂₀-alkanol alkoxylated with from 50 to 100 alkylene oxide units.

15. The fatliquoring agent as claimed in claim 11, wherein the polymer of the formula (I) has a viscosity of from 30 to 1,000 mPa·s, measured in the pure substance at 20° C.

16. The fatliquoring agent as claimed in claim 11, wherein, in the compound of the formula (II), R¹ and R², independently of one another, are selected from the group consisting of methyl, ethyl, propyl, isopropyl, n-butyl, sec-butyl, tert-butyl, n-pentyl, isopentyl, n-hexyl, 2-ethylhexyl, n-octyl, n-dodecyl, n-tridecyl, n-tetradecyl and n-hexadecyl and/or M⁺ is H⁺ or Na⁺.

17. The fatliquoring agent as claimed in claim 11, wherein said fatliquoring agent comprises from 45 to 98, % by weight of a component A or of a mixture of components A, from 2 to 15 by weight of a component B or of a mixture of components B, and from 0 to 20 by weight of a component C or of a mixture of components C, and from 0 to 20% by weight of a component D or of a mixture of components D, based in each case on the total weight of the fatliquoring agent.

18. Aqueous composition for the production and/or treatment of leather and hides, comprising 40 to 80% by weight of said fatliquoring agent as claimed in claim 1.

19. A process for fatliquoring in the production and/or treatment of leather and hides, wherein the leathers or hides are treated with aqueous liquors comprising said fatliquoring agent as claimed in claim 1.
